(19) United States
(12) Patent Application Publication
(10) Pub. No.: US 2026/0023164 A1
(43) Pub. Date: Jan. 22, 2026

(54) 3D LIDAR, AS WELL AS LEGGED ROBOT AND CLEANING ROBOT USING SAME

(71) Applicant: HANGZHOU YUSHU TECHNOLOGY CO.,LTD., Hangzhou, Zhejiang (CN)

(72) Inventors: Xingxing WANG, Hangzhou, Zhejiang (CN); Xiaoyang BAI, Hangzhou, Zhejiang (CN)

(21) Appl. No.: 18/880,826

(22) PCT Filed: Dec. 19, 2022
(86) PCT No.: PCT/CN2022/139877

§ 371 Date: Jan. 2, 2025

(30) Foreign Application Priority Data
Jul. 4, 2022 (CN) 202210779252.3

(51) Int. Cl. G01S 7/481; G01S 17/10; G01S 17/89

(52) U.S. Cl. CPC G01S 7/4817; G01S 7/4811; G01S 17/10; G01S 17/89

(57) ABSTRACT

A 3D lidar, a legged robot and a cleaning robot using same relate to the technical field of lidar equipment. The 3D lidar includes a vertical scanning unit and a horizontal rotating device. The vertical scanning unit includes a laser transmission port for transmitting a laser pulse signal and a reflector capable of rotating at a non-constant speed. The laser transmission port is provided on a rotation axis of the reflector, and the reflector scans an external environment by rotating at a constant or non-constant speed, to control a spatial distribution of a point cloud obtained by scanning. Through the rotation of the reflector at a constant or non-constant speed, the laser transmitter performs scanning in a vertical plane at a constant or non-constant speed, and the horizontal rotating device drives the rotation of the vertical scanning unit at a constant or non-constant speed.

### TECHNICAL FIELD

The present application relates to the technical field of lidar equipment, and in particular to a 3D lidar, as well as a legged robot and a cleaning robot using same.

### BACKGROUND

Currently, 3D lidar is widely used in fields such as industrial surveying and mapping, three-dimensional modeling and autonomous driving. However, most of the existing 3D lidars are multi-thread lidars, which are very expensive.

Chinese patent CN113960566A discloses a 3D lidar and a legged robot using same, wherein the 3D radar includes a vertical scanning unit and a horizontal rotating device enabling the vertical scanning unit to rotate in a horizontal direction; the vertical scanning unit includes a mounting base, and a laser receiver, a convex lens, a laser transmitter and a reflector sequentially provided on the mounting base, the laser receiver is provided at a focus position of the convex lens, the laser transmitter is provided on a main optical axis of the convex lens, the reflector is rotatably provided on the mounting base, and a rotation center of the reflector coincides with the main optical axis of the convex lens; the laser transmitter transmits a laser pulse signal to achieve surrounding environment scanning in a vertical plane through the rotation of the reflector and achieve three-dimensional environment scanning through the horizontal rotating device provided with a rotating motor.

### SUMMARY

### Technical Problems

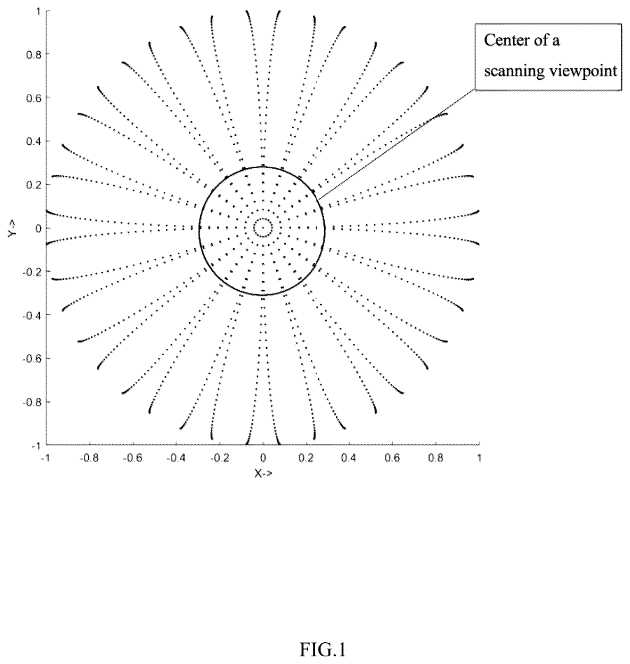

In the above technical solution, three-dimensional scanning of a single-thread lidar is achieved through the vertical scanning unit and the horizontal rotating device, greatly reducing costs. However, during use, it is found that as the vertical scanning unit and the horizontal rotating device both are constant-speed rotating structures, a point cloud acquired after scanning an external environment using the 3D lidar is extremely uneven, as shown in FIG. 1. Since an area on the top of the lidar is scanned once in each scan, the point cloud for the area is dense, that is, the center of a scanning viewpoint of the lidar is fixed in the area. However, the point cloud for an area surrounding the lidar is relatively sparse, resulting in a non-ideal acquisition effect. Therefore, there is a need to improve the 3D lidar, so that the center of the scanning viewpoint thereof can be in any particular area within its view angle.

### Solutions to Technical Problems

### Technical Solutions

In order to overcome the defects of the existing technology, a first purpose of the present application is to provide a 3D lidar, to adjust and control the center of a scanning viewpoint through a vertical scanning unit capable of scanning an external environment at a constant or non-constant speed and a horizontal rotating device capable of driving the vertical scanning unit to rotate at a constant or non-constant speed, thereby achieving concentrated high-density scanning of any area within the range of a view angle.

A second purpose of the present application is to provide a legged robot, which is equipped with the 3D lidar, to adjust and control the center of a scanning viewpoint through a vertical scanning unit capable of scanning an external environment at a constant or non-constant speed and a horizontal rotating device capable of driving the vertical scanning unit to rotate at a constant or non-constant speed, thereby achieving concentrated high-density scanning of any area within the range of a view angle.

A third purpose of the present application is to provide a cleaning robot, which is equipped with the 3D lidar, to adjust and control the center of a scanning viewpoint through a vertical scanning unit capable of scanning an external environment at a constant or non-constant speed and a horizontal rotating device capable of driving the vertical scanning unit to rotate at a constant or non-constant speed, thereby achieving concentrated high-density scanning of any area within the range of a view angle.

In order to achieve one of the above purposes, the present application adopts the following first technical solution:
a 3D lidar including a vertical scanning unit and a horizontal rotating device, wherein
the vertical scanning unit includes a laser transmission port for transmitting a laser pulse signal and a reflector capable of rotating at a constant or non-constant speed;
the laser transmission port is provided on a rotation axis of the reflector, and the reflector is capable of scanning an external environment by rotating at a constant or non-constant speed, to control a spatial distribution of a point cloud obtained by scanning; the horizontal rotating device is provided with a rotating motor for driving the vertical scanning unit to rotate horizontally at a constant or non-constant speed, to control the spatial distribution of the point cloud obtained by scanning.

As an exemplary technical measure, the reflector is a flat reflector; the vertical scanning unit includes a mounting base, and a laser receiver, a convex lens, the laser transmission port and the flat reflector sequentially provided on the mounting base, the laser receiver is provided at a focus position of the convex lens, the laser transmission port is provided on a main optical axis of the convex lens, the flat reflector is rotatably provided on the mounting base, and a rotation center of the flat reflector coincides with the main optical axis of the convex lens; the laser transmission port transmits a laser pulse signal, to achieve surrounding environment scanning in a vertical plane through the rotation of the flat reflector and achieve three-dimensional environment scanning through the horizontal rotating device.

As an exemplary technical measure, the reflector is a concave reflector; the vertical scanning unit includes a mounting base, and a laser receiver, the laser transmission port, the concave reflector and a first reflector provided on the mounting base), the laser receiver is provided at a focus position of the concave reflector, the concave reflector is rotatably provided on the mounting base with a rotation center thereof horizontally passing through the laser receiver, and the first reflector is fixedly provided on a reflective surface of the concave reflector and rotates along with the concave reflector; the laser transmission port transmits a laser pulse signal, to achieve surrounding environment scanning in a vertical plane through the rotation of the first reflector and achieve three-dimensional environment scanning through the horizontal rotating device, and the concave reflector receives and focuses a returned laser pulse signal to the focus thereof, where the laser pulse signal is received by the laser receiver.

As an exemplary technical measure, the vertical scanning unit further includes a laser transmitter and a second reflector; the laser transmitter is fixed to the bottom of the mounting base, and a laser pulse signaled transmitted by the laser transmitter is reflected back to the first reflector through the second reflector; and a light-tight shading channel is provided between the laser transmitter and the second reflector and between the second reflector and the first reflector. Fixing the laser transmitter at the bottom avoids excessively shielding the laser receiver from receiving an optical signal. The shading channel and a shading plate are provided to prevent the transmitted laser pulse signal and received laser pulse signal from interference by external ambient light, thereby improving scanning accuracy.

As an exemplary technical measure, the vertical scanning unit further includes a first motor and a first code disk, the first motor drives the reflector to rotate, the first code disk is concentrically and fixedly connected with the reflector, and rotation information of the reflector is acquired through the first code disk.

As an exemplary technical measure, an outer side of the mounting base is fixedly provided with a protective cover, the protective cover is fixedly connected with a lower casing, the mounting base is provided with a visible light transmitter, and visible light transmitted by the visible light transmitter is reflected by the second reflector and further reflected by the first reflector to form a specific pattern on the protective cover, or penetrates through the protective cover to display or draw a pattern on a surrounding external environment with the help of the horizontal rotating device. The structure may enable the 3D lidar to outwardly project visible light patterns, thus facilitating the display of varied information related to the radar itself and the robot, resulting in low costs and a simple structure.

As an exemplary technical measure, the horizontal rotating device includes an upper casing rotor, a lower casing and a motor stator fixed in the lower casing, and the motor stator is provided with magnetic steel sheets.

The mounting base is fixed on the upper casing rotor and rotates with the upper casing rotor.

As an exemplary technical measure, a circumference of the upper casing rotor is uniformly provided with through holes along the same circle, and the through holes form a photoelectric code disk to acquire rotation information of the upper casing rotor, thereby acquiring horizontal rotation information of the vertical scanning unit.

As an exemplary technical measure, a hollow wireless power transmission module is concentrically provided between the upper casing rotor and the lower casing, and the wireless power transmission module supplies power to the laser receiver and the laser transmitter. Due to the relative rotation between the upper casing rotor and the lower casing, when power supply and signal transmission are required, the wireless power transmission module is used for replacing a conventional cable, thus avoiding fatigue damage of the cable during reciprocating rotation.

As an exemplary technical measure, a base circuit board is fixedly provided on the lower casing, a wireless signal transmission component is concentrically provided between the upper casing rotor and the lower casing, and achieves wireless communication through optical communication; the laser transmitter and the laser receiver achieve wireless communication with the base circuit board through the wireless signal transmission component. The laser transmitter is electrically connected with a laser driving circuit board.

In order to achieve one of the above purposes, the present application adopts the following second technical solution:
a legged robot, which uses the 3D lidar described above to achieve real-time scanning of surrounding environment information.

In order to achieve one of the above purposes, the present application adopts the following third technical solution:

a cleaning robot including the 3D lidar described above.

### Beneficial Effects of the Present Application

### Beneficial Effects

The present application provides a 3D lidar, wherein through the rotation of the reflector at a constant or non-constant speed, the laser transmitter is enabled to perform scanning in a vertical plane at a constant or non-constant speed, and the horizontal rotating device drives the rotation of the vertical scanning unit at a constant or non-constant speed, to achieve the control of the spatial distribution of the scanning point cloud. For an area on the top of the 3D lidar, as the area is subjected to frequent reciprocating scanning, which may result in a dense point cloud, the reflector rotates quickly during the scanning of the area to obtain a sparse point cloud. During the scanning of an area surrounding the 3D lidar, the reflector rotates slowly to obtain a dense point cloud. As such, the overall distribution of the acquired point cloud is relatively even.

The present application provides a legged robot equipped with the 3D lidar, wherein through the rotation of the reflector at a constant or non-constant speed, the laser transmitter is enabled to perform scanning in a vertical plane at a constant or non-constant speed, and the horizontal rotating device drives the rotation of the vertical scanning unit at a constant or non-constant speed, to achieve the control of the spatial distribution of the scanning point cloud. For an area on the top of the 3D lidar, as the area is subjected to frequent reciprocating scanning, which may result in a dense point cloud, the reflector rotates quickly during the scanning of the area to obtain a sparse point cloud. During the scanning of an area surrounding the 3D lidar, the reflector rotates slowly to obtain a dense point cloud. As such, the overall distribution of the acquired point cloud is relatively even.

The present application provides a cleaning robot equipped with the 3D lidar, wherein through the rotation of the reflector at a constant or non-constant speed, the laser transmitter is enabled to perform scanning in a vertical plane at a constant or non-constant speed, and the horizontal rotating device drives the rotation of the vertical scanning unit at a constant or non-constant speed, to achieve the control of the spatial distribution of the scanning point cloud. For an area on the top of the 3D lidar, as the area is subjected to frequent reciprocating scanning, which may result in a dense point cloud, the reflector rotates quickly during the scanning of the area to obtain a sparse point cloud. During the scanning of an area surrounding the 3D lidar, the reflector rotates slowly to obtain a dense point cloud. As such, the overall distribution of the acquired point cloud is relatively even.

### BRIEF DESCRIPTION OF THE DRAWINGS

### Description of the Drawings

FIG. 1 is a diagram of a distribution of a point cloud acquired by an existing 3D lidar;

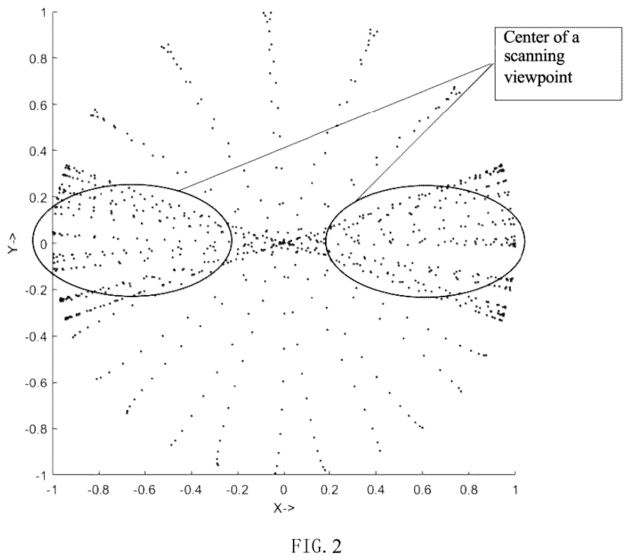

FIG. 2 illustrates an example of a distribution of a point cloud acquired by a 3D lidar according to the present application;

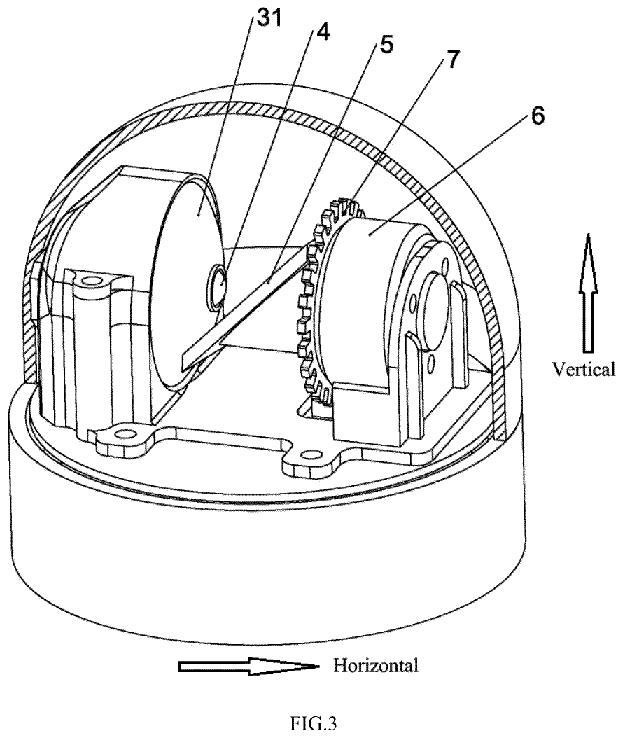

FIG. 3 is a structural diagram of a 3D lidar using a flat reflector according to the present application;

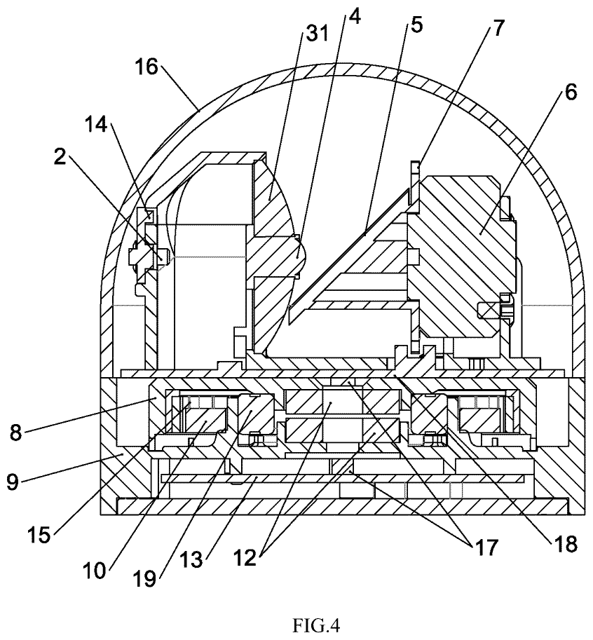

FIG. 4 is a full sectional view of a 3D lidar using a flat reflector according to the present application;

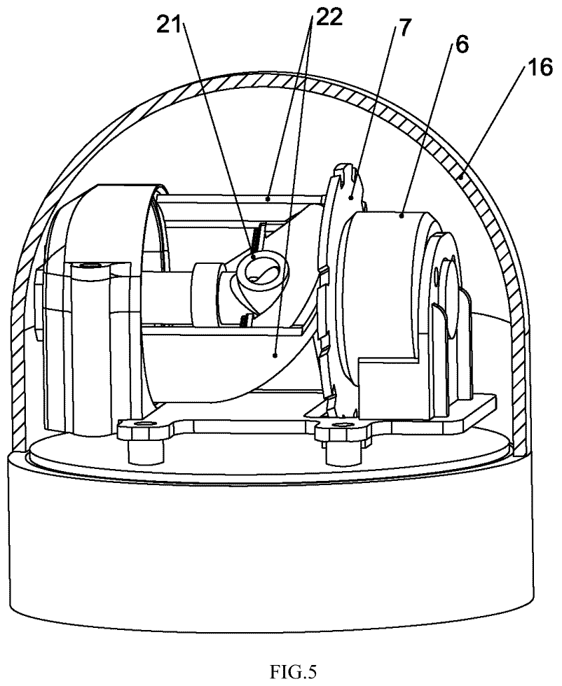

FIG. 5 is a structural diagram of a 3D lidar using a concave reflector according to the present application;

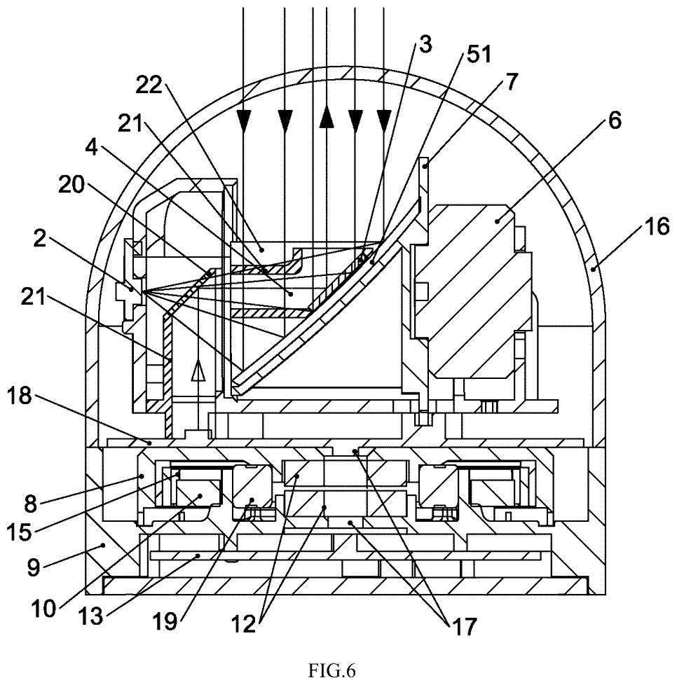

FIG. 6 is a full sectional view of a 3D lidar using a concave reflector according to the present application;

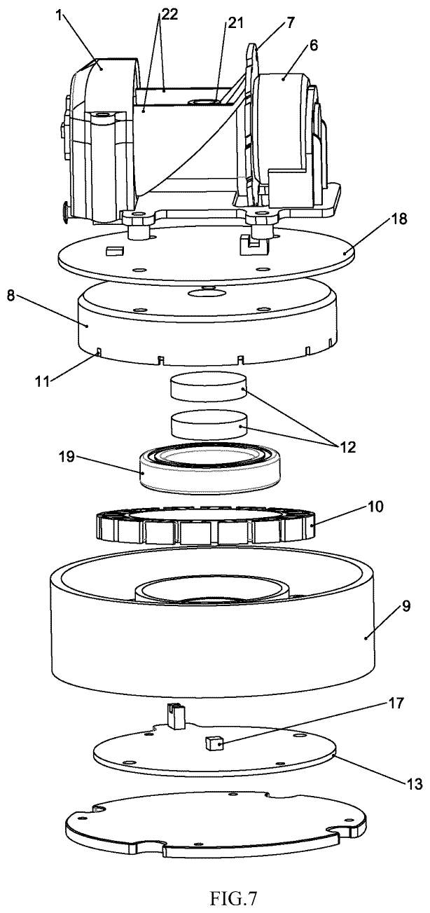

FIG. 7 is an exploded view of a 3D lidar using a concave reflector according to the present application;

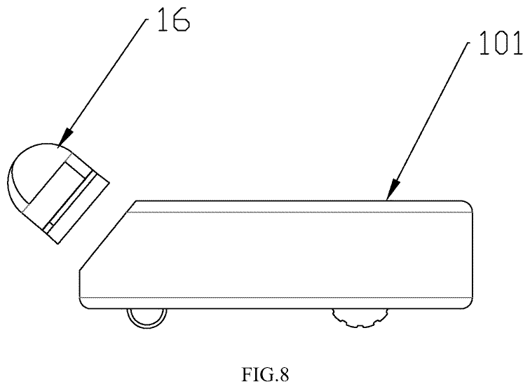

FIG. 8 is an exploded view of a cleaning robot according to the present application;

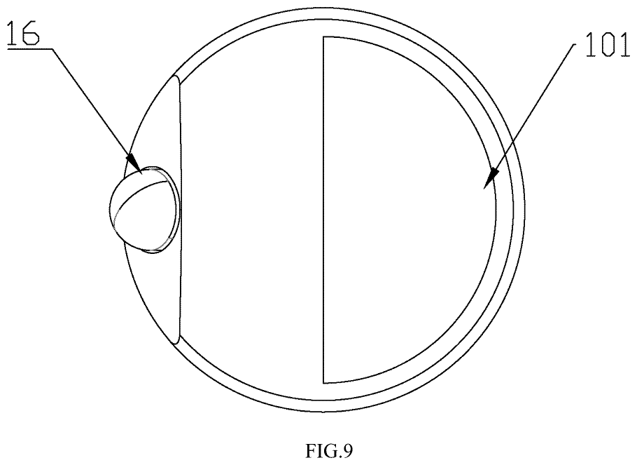

FIG. 9 is a top view of a cleaning robot according to the present application;

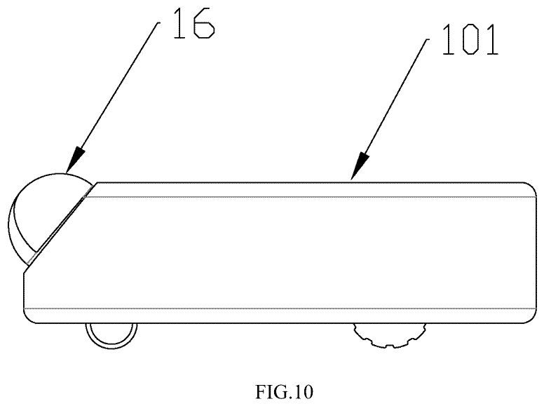

FIG. 10 is a side view of a cleaning robot according to the present application; and

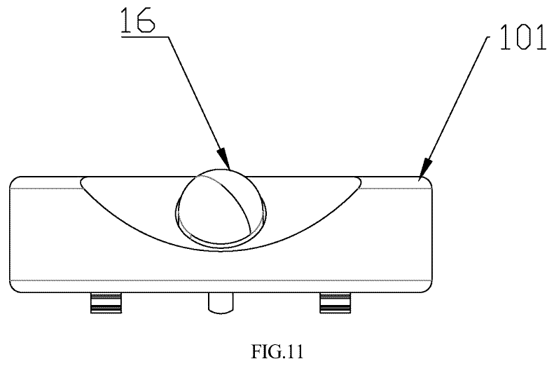

FIG. 11 is a front view of a cleaning robot according to the present application.

In the drawings, 1—mounting base; 2—laser receiver; 3—first reflector; 31—convex lens; 4—laser transmission port; 5—flat reflector; 51—concave reflector; 6—first motor; 7—first code disk; 8—upper casing rotor; 9—lower casing; 10—motor stator; 11—through hole; 12—wireless power transmission module; 13—base circuit board; 14—visible light transmitter; 15—magnetic steel sheet; 16—protective cover; 17—wireless signal transmission component; 18—laser driving circuit board; 19—horizontal rotating bearing; 20—second reflector; 21—shading channel; 22—shading plate; 101—cleaning robot body.

### DETAILED DESCRIPTION OF THE EMBODIMENTS

### Description of the Embodiments

The present application will be further described below in combination with the embodiments with reference to the drawings. It is to be understood that the embodiments or technical features described below may be freely combined to form new embodiments on the premise of not causing any conflict.

It should be noted that when two elements are “fixedly connected” or “fixed”, the two elements may be directly connected or be connected via an intermediate element. On the contrary, when an element is referred to as being “directly on” another element, there is no intermediate element. The terms “horizontal”, “vertical”, “up”, “down”, and similar expressions used herein are for descriptive purposes only.

Unless otherwise defined, all technical and scientific terms used herein have the same meanings as those commonly understood by those skilled in the technical field of the present application. The terms used herein are only for the purpose of describing specific embodiments and are not intended to limit the present application. The term “and/or” used herein includes any and all combinations of one or more listed items related thereto.

Referring to FIGS. 1-7, a specific embodiment of a 3D lidar according to the present application is as follows:

A 3D lidar includes a vertical scanning unit and a horizontal rotating device, wherein the vertical scanning unit includes a laser transmission port 4 for transmitting a laser pulse signal and a rotatable reflector; the laser transmission port 4 is provided on a rotation axis of the reflector, and the reflector scans an external environment by rotating at a constant or non-constant speed, to control a spatial distribution of a point cloud obtained by scanning; the horizontal rotating device drives the vertical scanning unit to rotate horizontally at a constant or non-constant speed, to control the spatial distribution of the point cloud obtained by scanning.

Referring to FIGS. 3-4, a specific embodiment of the use of a flat reflector 5 according to the present application is as follows:

The reflector is a flat reflector 5; the vertical scanning unit comprises a mounting base 1, and a laser receiver 2, a convex lens 31, the laser transmission port 4 and the flat reflector 5 sequentially provided on the mounting base 1, the laser receiver 2 is provided at a focus position of the convex lens 31, the laser transmission port 4 is provided on a main optical axis of the convex lens 31, the flat reflector 5 is rotatably provided on the mounting base 1, and a rotation center of the flat reflector 5 coincides with the main optical axis of the convex lens 31; the laser transmission port 4 transmits a laser pulse signal, to achieve surrounding environment scanning in a vertical plane through the rotation of the flat reflector 5 and achieve three-dimensional environment scanning through the horizontal rotating device.

Referring to FIGS. 5-7, a specific embodiment of the use of a concave reflector 51 according to the present application is as follows:

The reflector is a concave reflector 51; the vertical scanning unit comprises a mounting base 1, and a laser receiver 2, the laser transmission port 4, the concave reflector 51 and a first reflector 3 provided on the mounting base 1, the laser receiver 2 is provided at a focus position of the concave reflector 51, the concave reflector 51 is rotatably provided on the mounting base 1 with a rotation center thereof horizontally passing through the laser receiver 2, and the first reflector 3 is fixedly provided on a reflective surface of the concave reflector 51 and rotates along with the concave reflector 51; the laser transmission port 4 transmits a laser pulse signal, to achieve surrounding environment scanning in a vertical plane through the rotation of the first reflector 3 and achieve three-dimensional environment scanning through the horizontal rotating device, and the concave reflector 51 receives and focuses a returned laser pulse signal to the focus thereof, where the laser pulse signal is received by the laser receiver 2.

A specific embodiment of the vertical scanning unit according to the present application is as follows:

The vertical scanning unit further includes a laser transmitter, a second reflector 20, a first motor 6 and a first code disk 7.

The laser transmitter is fixed to the bottom of the mounting base 1, and a laser pulse signaled transmitted by the laser transmitter is reflected back to the first reflector 3 through the second reflector 20; and a light-tight shading channel 21 is provided between the laser transmitter and the second reflector 20 and between the second reflector 20 and the first reflector 3. Fixing the laser transmitter at the bottom avoids excessively shielding the laser receiver 2 from receiving an optical signal. The shading channel 21 and a shading plate 22 are provided to prevent the transmitted laser pulse signal and received laser pulse signal from interference by external ambient light, thereby improving scanning accuracy.

The first motor 6 drives the reflector to rotate, the first code disk 7 is concentrically and fixedly connected with the reflector, and rotation information of the reflector is acquired through the first code disk 7.

A specific embodiment of additionally providing a protective structure according to the present application is as follows:

An outer side of the mounting base 1 is fixedly provided with a protective cover 16, the protective cover 16 is fixedly connected with a lower casing 9, the mounting base 1 is provided with a visible light transmitter 14, and visible light transmitted by the visible light transmitter 14 is reflected by the second reflector 20 and further reflected by the first reflector 3 to form a specific pattern on the protective cover 16, or penetrates through the protective cover 16 to display or draw a pattern on a surrounding external environment with the help of the horizontal rotating device. The structure may enable the 3D lidar to outwardly project visible light patterns, thus facilitating the display of varied information related to the radar itself and the robot, resulting in low costs and a simple structure.

A specific embodiment of the horizontal rotating device according to the present application is as follows:

The horizontal rotating device includes an upper casing rotor 8, a lower casing 9, a horizontal rotating bearing 19 and a motor stator 10 fixed in the lower casing 9, the motor stator 10 is provided with magnetic steel sheets 15.

The mounting base 1 is fixed on the upper casing rotor 8 and rotates with the upper casing rotor.

A circumference of the upper casing rotor 8 is uniformly provided with through holes 11 along the same circle, and the through holes 11 form a photoelectric code disk to acquire rotation information of the upper casing rotor 8, thereby acquiring horizontal rotation information of the vertical scanning unit.

A specific embodiment of additionally providing a wireless power transmission module 12 according to the present application is as follows:

A hollow wireless power transmission module 12 is concentrically provided between the upper casing rotor 8 and the lower casing 9, and the wireless power transmission module 12 supplies power to the laser receiver 2 and the laser transmitter. Due to the relative rotation between the upper casing rotor 8 and the lower casing 9, when power supply and signal transmission are required, the wireless power transmission module 12 is used for replacing a conventional cable, thus avoiding fatigue damage of the cable during reciprocating rotation.

A specific embodiment of a signal transmission structure according to the present application is as follows:

A base circuit board 13 is fixedly provided on the lower casing 9, a wireless signal transmission component 17 is concentrically provided between the upper casing rotor 8 and the lower casing 9, and achieves wireless communication through optical communication; the laser transmitter and the laser receiver 2 achieve wireless communication with the base circuit board 13 through the wireless signal transmission component 17. The laser transmitter is electrically connected with a laser driving circuit board 18.

A first specific embodiment of application of the present application is as follows:

A legged robot uses the 3D lidar described above to achieve real-time scanning of surrounding environment information.

Referring to FIGS. 8-11, a second specific embodiment of application of the present application is as follows:

A cleaning robot includes the 3D lidar described above and a cleaning robot body 101.

An outer wall of the cleaning robot body 101 is equipped with the 3D lidar.

In the present application, the fixation or fixed connection may be screw connection, welding, riveting, inserting, or connection achieved via a third component, which can be selected by those skilled in the art according to an actual situation.

The above embodiments are only exemplary embodiments of the present application and are not intended to limit the scope of protection of the present application. Any non-substantive changes and replacements made by those skilled in the art based on the present application still fall within the scope of protection of the present application.

1. A 3D lidar, comprising:
a vertical scanning unit and a horizontal rotating device, wherein
the vertical scanning unit comprises a laser transmission port for transmitting a laser pulse signal and a reflector capable of rotating at a constant or non-constant speed;
the laser transmission port is provided on a rotation axis of the reflector, and the reflector is capable of scanning an external environment by rotating at a constant or non-constant speed, to control a spatial distribution of a point cloud obtained by scanning;
the horizontal rotating device is provided with a rotating motor for driving the vertical scanning unit to rotate horizontally at a constant or non-constant speed, to control the spatial distribution of the point cloud obtained by scanning.

2. The 3D lidar according to claim 1, wherein the reflector is a flat reflector; the vertical scanning unit comprises a mounting base, and a laser receiver, a convex lens, the laser transmission port and the flat reflector sequentially provided on the mounting base, the laser receiver is provided at a focus position of the convex lens, the laser transmission port is provided on a main optical axis of the convex lens, the flat reflector is rotatably provided on the mounting base, and a rotation center of the flat reflector coincides with the main optical axis of the convex lens;
the laser transmission port transmits a laser pulse signal, to achieve surrounding environment scanning in a vertical plane through the rotation of the flat reflector and achieve three-dimensional environment scanning through the horizontal rotating device.

3. The 3D lidar according to claim 1, wherein the reflector is a concave reflector; the vertical scanning unit comprises a mounting base, and a laser receiver, the laser transmission port, the concave reflector and a first reflector provided on the mounting base, the laser receiver is provided at a focus position of the concave reflector, the concave reflector is rotatably provided on the mounting base with a rotation center thereof horizontally passing through the laser receiver, and the first reflector is fixedly provided on a reflective surface of the concave reflector and rotates along with the concave reflector;
the laser transmission port transmits a laser pulse signal, to achieve surrounding environment scanning in a vertical plane through the rotation of the first reflector and achieve three-dimensional environment scanning through the horizontal rotating device, and the concave reflector receives and focuses a returned laser pulse signal to the focus thereof, where the laser pulse signal is received by the laser receiver.

4. The 3D lidar according to claim 3, wherein the vertical scanning unit further comprises a laser transmitter and a second reflector; the laser transmitter is fixed to the bottom of the mounting base, and a laser pulse signaled transmitted by the laser transmitter is reflected back to the first reflector through the second reflector; and a light-tight shading channel is provided between the laser transmitter and the second reflector and between the second reflector and the first reflector.

5. The 3D lidar according to claim 2, wherein the vertical scanning unit further comprises a first motor and a first code disk, the first motor drives the reflector to rotate, the first code disk is concentrically and fixedly connected with the reflector, and rotation information of the reflector is acquired through the first code disk.

6. The 3D lidar according to claim 5, wherein an outer side of the mounting base is fixedly provided with a protective cover, the protective cover is fixedly connected with a lower casing, the mounting base is provided with a visible light transmitter, and visible light transmitted by the visible light transmitter is reflected by the second reflector and further reflected by the first reflector to form a specific pattern on the protective cover, or penetrates through the protective cover to display or draw a pattern on a surrounding external environment with the help of the horizontal rotating device.

7. The 3D lidar according to claim 6, wherein the horizontal rotating device comprises an upper casing rotor, a lower casing and a motor stator fixed in the lower casing, the motor stator is provided with a number of magnetic steel sheets, and the mounting base is fixed on the upper casing rotor and rotates with the upper casing rotor.

8. The 3D lidar according to claim 7, wherein a circumference of the upper casing rotor is uniformly provided with through holes along the same circle, and the through holes form a photoelectric code disk to acquire rotation information of the upper casing rotor, thereby acquiring horizontal rotation information of the vertical scanning unit.

9. The 3D lidar according to claim 8, wherein a hollow wireless power transmission module is concentrically provided between the upper casing rotor and the lower casing, and the wireless power transmission module supplies power to the laser receiver and the laser transmitter.

10. The 3D lidar according to claim 9, wherein a base circuit board is fixedly provided on the lower casing, a wireless signal transmission component is concentrically provided between the upper casing rotor and the lower casing, and achieves wireless communication through optical communication; the laser transmitter and the laser receiver achieve wireless communication with the base circuit board through the wireless signal transmission component; and the laser transmitter is electrically connected with a laser driving circuit board.

11. A cleaning robot, comprising the 3D lidar according to claim 1.

12. The 3D lidar according to claim 4, wherein the vertical scanning unit further comprises a first motor and a first code disk, the first motor drives the reflector to rotate, the first code disk is concentrically and fixedly connected with the reflector, and rotation information of the reflector is acquired through the first code disk.

13. The 3D lidar according to claim 12, wherein an outer side of the mounting base is fixedly provided with a protective cover, the protective cover is fixedly connected with a lower casing, the mounting base is provided with a visible light transmitter, and visible light transmitted by the visible light transmitter is reflected by the second reflector and further reflected by the first reflector to form a specific pattern on the protective cover, or penetrates through the protective cover to display or draw a pattern on a surrounding external environment with the help of the horizontal rotating device.

14. The 3D lidar according to claim 13, wherein the horizontal rotating device comprises an upper casing rotor, a lower casing and a motor stator fixed in the lower casing, the motor stator is provided with a number of magnetic steel sheets, and the mounting base is fixed on the upper casing rotor and rotates with the upper casing rotor.

15. The 3D lidar according to claim 14, wherein a circumference of the upper casing rotor is uniformly provided with through holes along the same circle, and the through holes form a photoelectric code disk to acquire rotation information of the upper casing rotor, thereby acquiring horizontal rotation information of the vertical scanning unit.

16. The 3D lidar according to claim 15, wherein a hollow wireless power transmission module is concentrically provided between the upper casing rotor and the lower casing, and the wireless power transmission module supplies power to the laser receiver and the laser transmitter.

17. The 3D lidar according to claim 16, wherein a base circuit board is fixedly provided on the lower casing, a wireless signal transmission component is concentrically provided between the upper casing rotor and the lower casing, and achieves wireless communication through optical communication; the laser transmitter and the laser receiver achieve wireless communication with the base circuit board through the wireless signal transmission component; and the laser transmitter is electrically connected with a laser driving circuit board.
